(19) United States
(12) Patent Application Publication
(10) Pub. No.: US 2018/0262754 A1
(43) Pub. Date: Sep. 13, 2018

(54) IMAGE COMPRESSION APPARATUS, IMAGE DECODING APPARATUS, AND IMAGE PROCESSING METHOD

(71) Applicant: HITACHI, LTD., Tokyo (JP)

(72) Inventors: Hironori Komi, Tokyo (JP); Hiroaki Itou, Tokyo (JP); Yuusuke Yatabe, Tokyo (JP)

(73) Assignee: HITACHI, LTD., Tokyo (JP)

(21) Appl. No.: 15/757,544

(22) PCT Filed: Oct. 5, 2015
(86) PCT No.: PCT/JP2015/078213

§ 371 Date: Mar. 5, 2018

(51) Int. Cl. H04N 19/117; H04N 19/513; H04N 19/176; H04N 19/577; H04N 19/107

(52) U.S. Cl. CPC H04N 19/117; H04N 19/521; H04N 19/107; H04N 19/577; H04N 19/176

(57) ABSTRACT

In order to improve both image quality and encoding efficiency when an image is compressed/encoded, transmitted, and recorded, an image compression apparatus includes a motion search units that perform motion detection between a first frame as an input image and a reference image already created in compression/encoding, a temporal filter that performs temporal filtering for the first frame using a second frame different from the input image on the basis of a result of the motion detection, and a compression/encoding units that compress/encode an image subjected to the temporal filtering. The temporal filter determines a location of the reference image and a filter characteristic on the basis of an encoding parameter used by the compression/encoding unit.

### CROSS REFERENCE TO PRIOR APPLICATIONS

This application is a U.S. National Phase application under 35 U.S.C. § 371 of International Application No. PCT/JP2015/078213, filed on Oct. 5, 2015. The International Application was published in Japanese on Apr. 13, 2017 as WO 2017/060951 A1 under PCT Article 21(2). The contents of the above applications are hereby incorporated by reference.

### TECHNICAL FIELD

The present invention relates to a technology for efficiently compressing and/or decompressing an image and reducing an adopted transmission band when the image is transmitted or recorded.

### BACKGROUND ART

In recording of digital image data or transmission via a network, in order to suppress a data rate, typically, compression/encoding is performed on the basis of an image compression standard represented by H.264/AVC. In this compression/encoding, motion compensation is performed using data of other reference frames called a reference image stored in advance for each small pixel region obtained by dividing each image frame into a plurality of blocks, and pixel difference information (residual information) between the reference frame and the original frame is employed. In this case, in order to reduce the difference information of each pixel as little as possible, high-accuracy block matching motion prediction is employed. For this purpose, in order to detect a motion vector for each block with high accuracy, a circuit is required to have a wide search range. In addition, the motion prediction is necessarily performed in a resolution range equal to or smaller than a pixel unit (sub-pixel accuracy). This increases a circuit size.

Meanwhile, a lot of noise components existing in a target input image for compression/encoding significantly affect the accuracy of the motion prediction. For example, when a video camera takes images in a dark place, it is necessary to increase sensitivity of an image sensor (increase an amplification gain in an electrical sense). This also amplifies noise and generates significant white noise compared to a signal level of a subject. For this reason, although it is necessary to perform motion prediction such that a motion vector indicates the same portion of the subject between frames during the motion prediction, accidentally, the motion vector erroneously indicates a portion where energy of pixel difference between noise components is small. As a result, the image data of the subject desired to maintain high image quality originally has a large difference, and encoding information for motion compensation is allocated for removing the noise components. This degrades encoding efficiency.

As a technique for suppressing the white noise described above, a time-directed filtering process called a temporal filter or three-dimensional noise filter is known in the art. The temporal filter detects a portion having the same picture pattern between a plurality of frames as a motion vector, performs filtering for averaging pixel values between these portions, and repeating the temporal filtering for the subsequent frames. As a result, the picture of the original input image is maintained, and only a random noise component is cancelled. Even in this temporal filter, since motion prediction is performed to obtain a motion vector, the circuit size increases. For example, in the case of a large-scale integration (LSI) circuit, an occupation ratio of a chip becomes a problem in practical use.

In this regard, Patent Document 1 proposes a technique of performing a noise removal process and an encoding process by commonly using the calculated motion vector. In Patent Document 1, it is stated that “a first aspect of this technique is an image processing device including: a motion detection unit that performs motion detection by using input images to calculate a motion vector; a noise removal processing unit that performs a noise removal process for the input image using the motion vector calculated by the motion detection unit; and an encoding processing unit that performs encoding for the noise removal image generated by the noise removal processing unit using the motion vector calculated by the motion detection unit.”

### CITATION LIST

### Patent Document

Patent Document 1: JP 2013-223007 A

### SUMMARY OF THE INVENTION

### Problems to be Solved by the Invention

In the technique of Patent Document 1, it is not necessary to provide the motion detection unit in each of the noise removal processing unit that performs temporal filtering and the encoding processing unit that performs the encoding process for the noise removal image. Therefore, the circuit size can be reduced.

However, the temporal filter of the related art has been designed by focusing on noise reduction. When the temporal filter is used for improvement of encoding efficiency during image compression rather than improvement of image quality, it is difficult to directly apply temporal filtering to a portion where compression efficiency is degraded. In addition, it is difficult to use the temporal filter when it is desirable that image quality of a particular portion in a screen is to be controlled to improve the compression efficiency. In addition, it is difficult for a decoding side to reproduce the image once subjected to the temporal filtering as close as the original image previous to the temporal filtering. The related art including Patent Document 1 fails to consider such a problem.

In order to address the aforementioned problems, an object of the present invention is to implement an image compression apparatus and an image decoding apparatus that can be easily used by improving both image quality and encoding efficient when the image is compressed/encoded, transmitted, and recorded.

### Solutions to Problems

According to an aspect of the invention, there is provided an image compression apparatus, including: a motion search unit that performs motion detection for each small area in an image between a first frame as an input image and a reference image already created in compression/encoding; a temporal filter that performs temporal filtering for the first frame using a second frame different from the input image on the basis of a result of the motion detection; a compression/encoding unit that performs computation of a difference from a predicted image, frequency transformation, quantization, and variable-length encoding for an image subjected to the temporal filtering; and an encoding parameter control unit that controls an encoding parameter in the compression/encoding unit, in which the temporal filter determines a location of the reference image and a filter characteristic on the basis of an encoding parameter selected by the encoding parameter control unit.

According another aspect of the invention, there is provided an image decoding apparatus including: a decompression/decoding unit that receives a compressed/encoded stream subjected to temporal filtering and decompresses and decodes the stream; and a temporal filter restoration unit that performs inverse transformation of the temporal filtering for the decompressed/decoded image, in which the temporal filter restoration unit determines a location of a reference image and a filter characteristic for inverse transformation of the temporal filtering on the basis of an encoding parameter obtained in decompression/decoding of the decompression/decoding unit and restores an image previous to the temporal filtering.

### Effects of the Invention

According to the present invention, it is possible to implement an image compression apparatus and an image decoding apparatus that can be easily used by improving both image quality and encoding efficiency when the image is compressed/encoded, transmitted, and recorded.

### BRIEF DESCRIPTION OF THE DRAWINGS

FIG. 1 is a diagram illustrating a block configuration of an image compression apparatus according to a first embodiment.

FIG. 2 is a diagram illustrating an exemplary reference relationship between input frames.

FIG. 3 is a diagram illustrating an example of removal of white noise in an image.

FIG. 4 is a diagram illustrating a motion prediction process using an image.

FIG. 5 is a diagram illustrating a noise reduction effect of the reference image.

FIG. 6 is a diagram illustrating a flow of an encoding process including a temporal filter.

FIG. 7 is a diagram illustrating an exemplary reference relationship between frames according to a second embodiment.

FIG. 8 is a diagram illustrating a flow of an encoding process including a temporal filter.

FIG. 9 is a diagram illustrating an exterior configuration of a network camera according to a third embodiment.

FIG. 10 is a diagram illustrating a block configuration of an image processing system.

FIG. 11 is a diagram illustrating an exemplary setting of an attention area.

FIG. 12 is a diagram illustrating a relationship between a degree of attention β and a coefficient α used in filtering.

FIG. 13 is a diagram illustrating a flow of an encoding process including a temporal filter.

FIG. 14 is a diagram illustrating a block configuration of an image compression apparatus according to a fourth embodiment.

FIG. 15 is a diagram illustrating a block configuration of an image processing system according to a fifth embodiment.

FIG. 16 is a diagram illustrating a flow of an encoding process including a temporal filter.

FIG. 17 is a diagram illustrating a flow of a decoding process including temporal filtering restoration.

FIG. 18 is a diagram illustrating a block configuration of an image recording/reproduction system according to a sixth embodiment.

FIG. 19 is a diagram illustrating a block configuration of an image compression apparatus according to a seventh embodiment.

### MODE FOR CARRYING OUT THE INVENTION

Embodiments of the invention will now be described with reference to the accompanying drawings.

### First Embodiment

In a first embodiment, an image compression apparatus that receives a digital image as an input, performs real-time compression/encoding, and outputs an image bit stream will be described. Note that, in this embodiment, it is assumed that image compression is performed on the basis of the H.264/AVC (ISO/IEC 14496-10) standard.

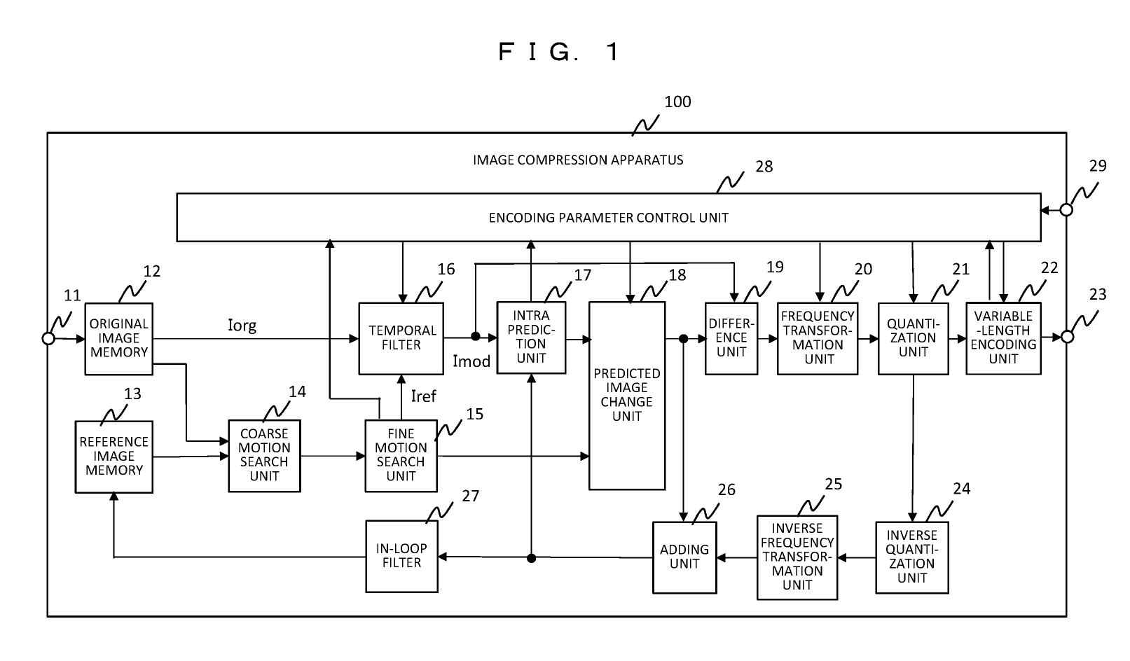

FIG. 1 is a diagram illustrating a block configuration of an image compression apparatus according to the first embodiment. First, an overview of the image compression apparatus 100 will be described.

An image input from an image input terminal 11 is stored in an original image memory 12 and is transmitted to a coarse motion search unit 14, a fine motion search unit 15, and a temporal filter 16. The reference image memory 13 stores a reference image subjected to the image compression, and the coarse motion search unit 14 and the fine motion search unit 15 perform motion prediction using the reference image. The temporal filter 16 performs temporal filtering to reduce white noise (random noise) using the original image from the original image memory 12 and the reference image from the fine motion search unit 15. The encoding parameter control unit 28 receives encoding parameters such as a block segmentation mode or a motion vector and controls temporal filtering or image compression using the encoding parameter.

In the image compression process, intra prediction of an intra prediction unit 17 and inter frame prediction of a predicted image change unit 18 are performed for an image subjected to temporal filtering. Then, a computation of a difference for the predicted image using a difference unit 19, a frequency transformation process using a frequency transformation unit 20, a quantization process using a quantization unit 21 are performed, and a variable-length encoding process is performed using a variable-length encoding unit 22. A resulting image bit stream is output from a bit stream output terminal 23 to the outside.

Note that the prediction mode or the motion vector in the middle is transmitted from the encoding parameter control unit to the variable-length encoding unit 22, and is appropriately encoded pursuant to a compression standard. In this case, the encoding parameter control unit 28 determines coarseness of quantization (quantization step) in the quantization unit 21 and performs control such that a final bit rate becomes a target bit rate. The terminal 29 is used in a third embodiment described below and receives information regarding the attention area.

For the data quantized by the quantization unit 21, an inverse quantization process using an inverse quantization unit 24, an inverse frequency transformation process using an inverse frequency transformation unit 25, and an adding operation using the adding unit 26 for addition to the predicted image are performed. Then, a process using an in-loop filter 27 such as a deblock filter is performed, and resulting data is stored in the reference image memory 13 as a reference image.

In this manner, in the image compression/encoding, each frame is compressed/encoded, and is decompressed by the image compression apparatus 100 to obtain a decoded image. Then, for the frame to be encoded, motion compensation is performed by using the decoded image as a reference image. In addition, compression/encoding is performed for the image subjected to the temporal filtering as a reference image used by the temporal filter 16, and an image obtained by decoding (local decoding) the compressed/coded image is used by looping back it.

Operations of each functional block will now be described with reference to the accompanying drawings as appropriate. Note that typical processing blocks for image compression out of the blocks will not be described for simplicity purposes.

For example, a full-HD resolution (1920×1080) image is input from the image input terminal 11 at a frame rate of 60 Hz. Each input image is temporarily stored in the original image memory 12 as frame data.

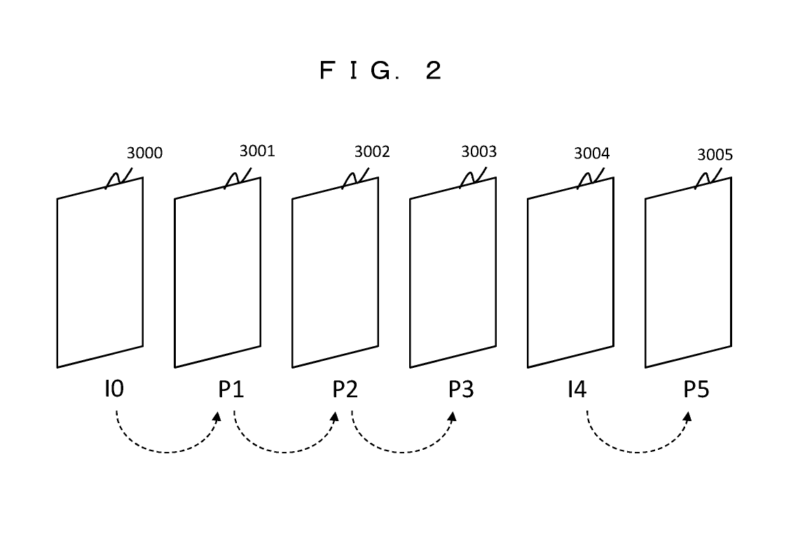

FIG. 2 is a diagram illustrating an exemplary reference relationship between input frames. Reference numerals 3000 to 3005 denote image frames of an input sequence. Each frame consists of any one of an intra picture (hereinafter, referred to as an “I-picture”) that performs encoding using a decoded image only within a screen and a predictive picture (hereinafter, referred to as a “P-picture”) that performs motion compensation from the reference image.

Each frame is denoted by a reference symbol indicating one of the I-picture or the P-picture and a reference numeral indicating an encoding sequence. For example, the frame “I4” refers to an I-picture encoded in the fourth order from a zero start point, and the frame “P3” refers to a P-picture encoded in the third order from the zero start point. In each dashed arrow between frames, a start point of the arrow indicates a reference frame, and an end point indicates a frame that performs motion compensation by referencing the frame of the start point. For example, the dashed arrow from the picture P2 to the picture P3 indicates that motion compensation for the picture P3 is performed by referencing the picture P2 for encoding.

The temporal filter 16 removes white noise. An overview of the white noise will be described.

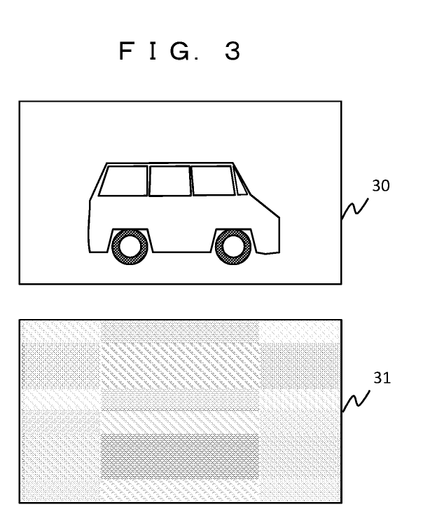

FIG. 3 is a diagram illustrating an example of removal of white noise within an image. In description of the noise removal effect, removal of white noise which is likely to occur due to an increase of a sensor gain especially at low illumination will be described for easy understanding purposes.

The image 30 is an example obtained when a subject image is photographed well. The image 31 shows an example in which a lot of white noise is generated. The white noise is noise distributed across the overall spatial frequencies in a frequency domain and is not easily removed using filters applied in a two-dimensional direction including horizontal and vertical directions within an image frame, such as a lowpass filter, a high-pass filter, and a band-pass filter.

The coarse motion search unit 14 and the fine motion search unit 15 perform motion prediction for an input image. For motion prediction, the reference image memory 13 stores reference images obtained during the compression/encoding in advance. The reference image is transmitted to the coarse motion search unit 14 for motion compensation with the input frame. The coarse motion search unit 14 and the fine motion search unit 15 obtain a high-correlation location of the reference image for each unit block (such as 16×16 pixels, 8×8 pixels, and 4×4 pixels) of the original image side defined in the H.264/AVC standard and obtain a difference between the high-correlation location and the block location as a motion vector. This is called “motion prediction.”

In typical motion prediction, two-dimensional block matching is performed to obtain a sum of absolute differences (SAD) between images and find a motion vector having the minimum SAD. In this case, since the block matching between frames necessitates an abundant computation amount, for example, an original image is down-sampled at a half resolution for a process of computing the motion vector in a wide range in order to reduce the computation amount. This is called coarse search. Then, for a region indicated by the motion vector obtained through the coarse search, fine search is performed by strictly conducting motion prediction up to a sub-pixel unit of a quarter (¼) pixel accuracy.

For the aforementioned process, the coarse motion search unit 14 receives the original image data and the reference image data from the original image memory 12 and the reference image memory 13, respectively, temporarily lowers resolutions of both data through down-sampling, and then computes the motion vector. Then, the original image data and one neighboring reference image indicated by the motion vector are transmitted from the coarse motion search unit 14 to the fine motion search unit 15. The fine motion search unit 15 computes a final motion vector through fine motion prediction.

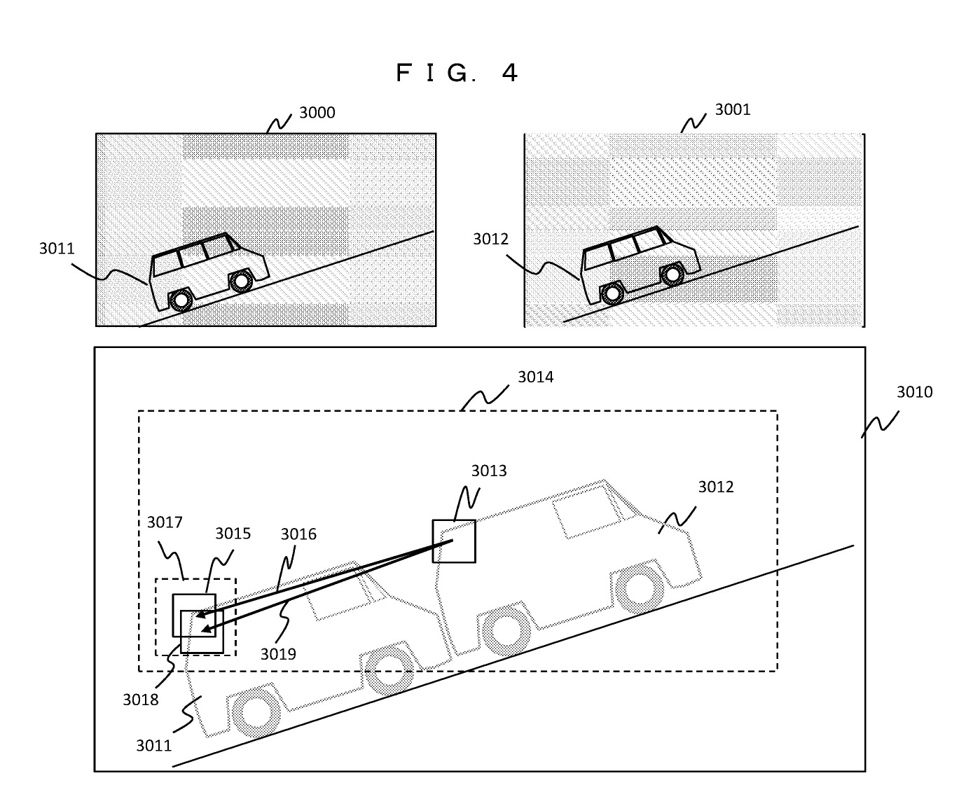

FIG. 4 is a diagram illustrating a motion prediction process using an image. Here, the processing in the coarse motion search unit 14 and the fine motion search unit 15 will be described by assuming that the frame 3000 is set as a reference image, and an original image of the frame 3001 is input. A screen 3010 is obtained by overlapping main pictures of the frames 3000 and 3001 in the same frame for simplicity purposes. Here, a subject (vehicle in this example) 3011 of the frame 3000 and a subject (vehicle in this example) 3012 of the frame 3001 are characteristic pictures. Note that, although white noise is not illustrated for simplicity purposes, the image data will be treated in computation by assuming that there is noise.

Here, it is assumed that an original image of the block 3013 (here, having a size of 16×16 pixels) of the frame 3001 is input from the original image memory 12. In this case, first, the coarse motion search unit 14 performs motion detection by down-sampling the original image and the reference image for the image region 3014 (here, ±40 pixels in the horizontal direction and ±16 pixels in the vertical direction) in the vicinity of a particular range from a center of the block 3013.

As a result of the coarse search, the block 3015 of the reference image has the highest correlation, and the motion vector 3016 directed from the block 3013 to the block 3015 is transmitted to the fine search unit 15 as a result of computation of the coarse search unit 14. In addition, an image region 3017 (±2 pixels in the horizontal direction and ±2 pixels in the vertical direction) in the vicinity of a particular range from the center of the block 3015 and an image previous to the down-sampling for the block 3013 are transmitted from the coarse search unit 14 to the fine search unit 15.

Then, the fine motion search unit 15 performs block matching between the image region 3017 and the block 3013. In this example, assuming that the block 3018 is a location having the minimum SAD, the motion vector 3019 directed from the block 3013 to the block 3018 is transmitted to the encoding parameter control unit 28 for the subsequent encoding as a result of computation of the fine motion search unit 15.

Although not illustrated in this example, in practice, instead of a fixed block size such as 16×16 pixels, a block (such as 4×4 pixels or 8×8 pixels) having a unit of the motion prediction available in the H. 264/AVC standard is also segmented within a corresponding macroblock of 16×16 pixels. In addition, a total sum of the motion prediction and SAD is calculated, a code amount of the motion vector is added, and a block segmentation mode and a motion vector predicted as having highest encoding efficiency are transmitted to the encoding parameter control unit 28.

The reference image portion resulting from the motion prediction is transmitted to the predicted image change unit 18 as a reference image for subsequent motion compensation and is also transmitted to the temporal filter 16.

Next, temporal filtering using an original image and a reference image subjected to the motion prediction as a characteristic of this embodiment will be described. The temporal filter 16 receives a block segmentation mode of the motion prediction and a corresponding motion vector via the encoding parameter control unit 28, receives a block segmentation mode and a corresponding reference image from the fine motion search unit 15, and performs temporal filtering between the original image and the reference image.

Details of the processing of the temporal filter 16 will be described.

Equation (1) expresses typical temporal filtering. Note that, in the following equations, “(x, y)” denotes horizontal and vertical image positions in a corresponding block.

I mod(x,y)=α·Iorg(x,y)+(1−α)Iref(x,y) (1),

where “Iorg(x, y)” denotes original image data of the block, “Iref(x, y)” denotes reference data corresponding to the block, “Imod(x, y)” denotes original image data subjected to temporal filtering corresponding to the block, and “α” denotes a weighting coefficient for synthesis (0<α≤1).

It is considered that “Iorg(x, y)” and “Iref(x, y)” are approximate values for a picture of a subject for which it is desired to maintain an original resolution by processing each macroblock of each original image using the temporal filter 16. Therefore, “Imod (x, y)” has a value close to “Iorg,” and degradation of image quality does not easily occur.

When the original image has a pixel suffering from random noise, and the motion prediction is sufficiently accurate, Equation (1) can be modified as Equation (2).

$$\begin{matrix}Imod ( x , y ) = α ( Is ( x , y ) + In ( x , y ) ) + ( 1 - α ) Iref ( x , y ) \\ = α ( Is ( x , y ) + In ( x , y ) ) + ( 1 - α ) Is ( x , y ) \\ = Is ( x , y ) + α \cdot In ( x , y ) ,\end{matrix} \qquad ( 2 )$$

where “Is(x, y)” denotes a pixel value desired to photograph the original subject in the original image, and “In(x, y)” denotes a random noise component in the original image.

Therefore, when the coefficient α is smaller than 1, a noise suppression effect is exhibited.

In comparison, when a reference image has random noise, and the noise of the original image is small, Equation (3) is obtained.

$$\begin{matrix}Imod ( x , y ) = α ( Is ( x , y ) ) + ( 1 - α ) ( Irs ( x , y ) + Irn ( x , y ) ) \\ = ( α \cdot Is ( x , y ) + ( 1 - α ) Irs ( x , y ) ) + ( 1 - α ) Irn ( x , y ) \\ \approx Is ( x , y ) + ( 1 - α ) Irn ( x , y ) ,\end{matrix} \qquad ( 3 )$$

where “Irs(x, y)” denotes a pixel value desired to express the original subject in the reference image without noise (“≈Is(x, y)” refers to a case where the accuracy of the motion prediction is high), and “Irn(x, y)” denotes a random noise component in the reference image.

Since the reference image Iref(x, y) is obtained by compressing and encoding Imod(x, y) as described above, performing local decoding, and looping back the result of the local decoding, a coefficient effect of reducing two items In(x, y) and Irn(x, y) of Equations (2) and (3) is accumulated. As a result, noise in the reference image is reduced by repeating the encoding.

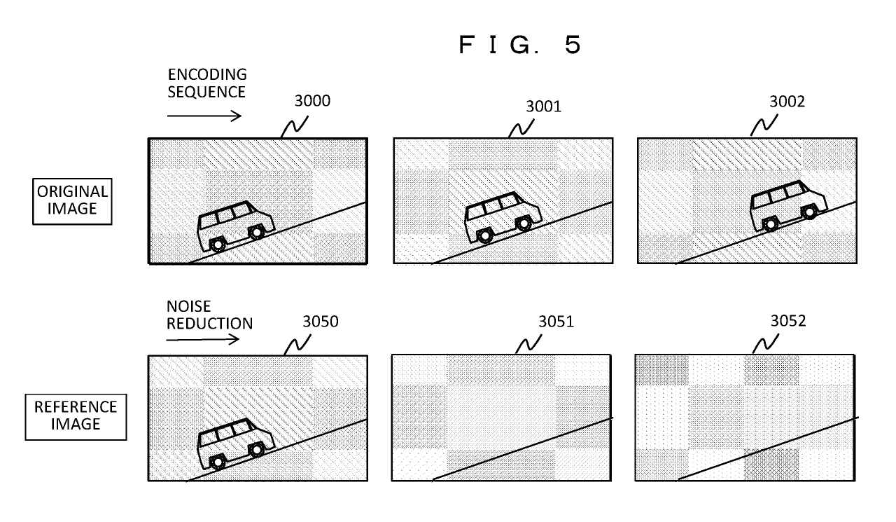

FIG. 5 is a diagram illustrating a noise reduction effect in a reference image. As encoding for an original image is progressed in order of 3000 to 3002, noise of the corresponding reference image is gradually reduced in order of 3050 to 3052. The reason will be described as follows.

In the related art, a temporal filter (three-dimensional noise filter) has been employed in order to remove random noise. However, the image used as a reference image is not an image subjected to local decoding at the time of image compression unlike this embodiment, but is obtained by motion prediction and weighted synthesis between images stored in the original image memory that have been input so far. For this reason, although some noise removal effects can be expected, it is difficult to obtain the characteristic effect of this embodiment from the following viewpoint.

First, when synthesis and filtering are performed for the original image and the reference image as expressed in Equation (1), a target frame is synthesized with the original image existing before it was input. For this reason, when quantization is performed by taking a difference from the reference image to be performed during image compression, a processing for indirectly dropping detailed information is performed. Therefore, image degradation further occurs.

In comparison, in the method according to this embodiment, since synthesis with the reference image used in the compression/encoding is performed in the filtering, computation of the difference unit 19 thereafter is expressed as Equation (4).

$$\begin{matrix}Imod - Iref = α \cdot Iorg + ( 1 - α ) Iref - Iref \\ = α ( Iorg - Iref )\end{matrix} \qquad ( 4 )$$

In this manner, the difference value can be reduced from the difference value (Iorg−Iref) used in the image compression of the related art by the coefficient α (≤1).

Here, when the coefficient α is set to smaller than 1, it works to increase the compression efficiency. This is an effect caused by the characteristic of this embodiment in which the reference image used for the temporal filter 16 is set to be identical to the reference image used for compression encoding. That is, according to this embodiment, it is possible to directly utilize the temporal filter in order to create the effect of noise removal for high image quality and the effect of improving encoding efficiency by reducing the difference value having a prediction error.

It is also possible to perform a variable control depending on a frame type or a motion vector to which the coefficient α is applied.

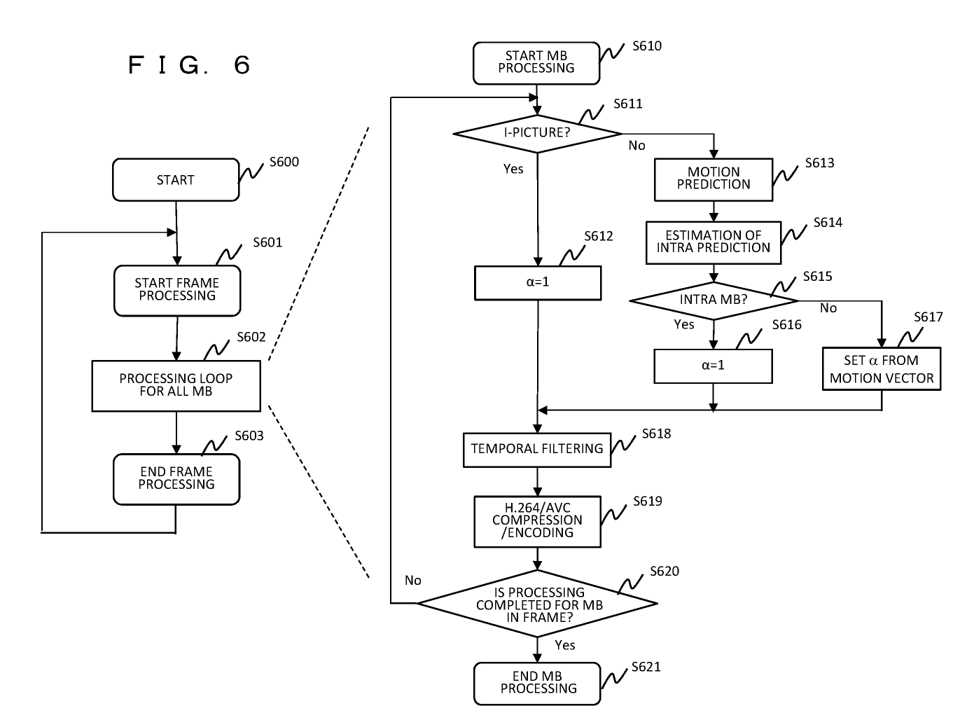

FIG. 6 is a diagram illustrating a flow of the encoding process including a temporal filter and includes an optimum setting of the coefficient α.

In S601, encoding for a layer higher than the macroblock MB is performed. In S602, the processing for each macroblock MB is performed within the loop illustrated in the right side.

In S611, a frame type is determined. In the case of the I-picture, the temporal filtering is not performed in this embodiment. Therefore, in S612, the coefficient is set to “α=1.” Meanwhile, in the case of pictures other than the I-picture, motion prediction is performed in S613. Then, estimation of the intra prediction in S614 and determination of a prediction result in S615 are performed. If it is determined that the picture belongs to a macroblock MB of intra prediction, the coefficient is set to “α=1” in S616. If it is determined that the picture belongs to a macroblock MB of inter prediction, a variable control is performed for the coefficient α from the motion vector in S617.

When the motion vector of the macroblock MB is large in S617, a correlation between the original image and the reference image becomes low. Therefore, the coefficient α is set to be large. When the motion vector is small, the correlation with the reference image is high. Therefore, the coefficient α is set to be small. In this case, even when the coefficient α is set to be small, it is possible to efficiently reduce noise without affecting the component of “Is (x, y).”

In S618, temporal filtering expressed in Equation (1) is performed. In S619, compression/encoding pursuant to H.264/AVC is performed. In S620, the process is looped until the processing is completed for all macroblocks MB in the frame.

Another effect of this embodiment is reduction of image reading frequency. In the related art, for temporal filtering, it was necessary to read an external memory twice in total, one for reading the original image and the other for reading the reference image for motion prediction. In comparison, according to this embodiment, it is sufficient to read the reference image only once. In general, the reference image is stored in a large capacity memory such as a DDR-SDRAM, and memory access is concentrated on this memory disadvantageously. According to this embodiment, it is possible to reduce reference image reading frequency and improve use efficiency of a memory bandwidth. Therefore, it is possible to lower a frequency of the entire system. When a program executed in an LSI or a processor is embedded, it is possible to select a low-speed device, and this leads to cost reduction.

Although the H.264/AVC standard is employed as an image compression standard in this embodiment, other compression standards using motion compensation such as H.265/HEVC may also be employed. It is obvious that similar functional effects can be obtained by associating the motion prediction location as a target of temporal filtering with the motion compensation location and using the reference image used in the motion compensation as the reference image of the temporal filtering.

In the temporal filtering according to this embodiment, the original image and the reference image are synthesized as expressed in Equation (1), but the invention is not limited thereto. It is obvious that any filter is within the technical scope of this embodiment as long as it receives the original image and the reference image as input data and performs filtering so as to reduce the difference from the reference image.

### Second Embodiment

In a second embodiment, compression/encoding using a B-picture that performs bidirectional prediction will be described. A configuration of the image compression apparatus is similar to that of FIG. 1.

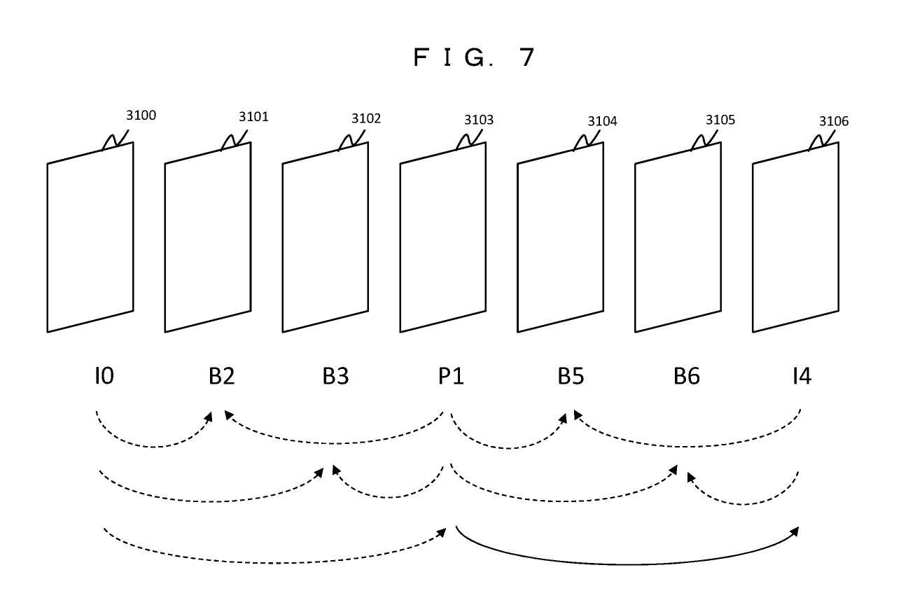

FIG. 7 is a diagram illustrating an exemplary reference relationship between frames according to the second embodiment. For the input frames 3100 to 3106, a bidirectional predictive picture (hereinafter, referred to as a B-picture) that performs bidirectional prediction is employed in addition to the I-picture and the P-picture. The dashed arrow between frames indicates a reference relationship at the time of motion compensation. During encoding of the B-picture, an image input after the frame to be encoded is encoded as the I-picture or the P-picture in advance, and motion compensation is performed for the input image retrogressed using the reference result. For example, in the frame 3101 (B2 frame), a pair of frame images I0 and P1 are used as the reference image. When a pair of frame images are used in motion compensation, whether both images are averaged or whether the other image is referenced can be selected depending on a frame selection method prepared in the encoding standard.

In the filtering using the temporal filter 16 according to this embodiment, computation is performed as expressed in the computation equations of the first embodiment using a plurality of reference images created for B-picture encoding. In this method, it is possible to perform temporal filtering using the same reference image as that used in encoding and also obtain all the effects of the first embodiment in the B-picture. In addition, in the method of the related art, a plurality of reference images are not used in this manner. Therefore, in particular, the white noise removal effect in the B-picture is significantly improved using this method.

In this embodiment, the solid arrows are illustrated from the frame P1 to the frame I4 in FIG. 7. However, these indicate a reference relationship only for the case of the temporal filtering. That is, inter prediction is not performed as in the compression encoding of the related art for the I-picture (I4). However, the coarse motion search unit 14 and the fine motion search unit 15 are operated to perform temporal filtering, and the temporal filtering is performed by using the immediately preceding frame P1 as a reference image. As a result, it is possible to suppress an abrupt change of the image quality that may be generated when only the I-picture is not subjected to temporal filtering. In addition, it is possible to provide uniform image quality for the I-picture, the P-picture, and the B-picture.

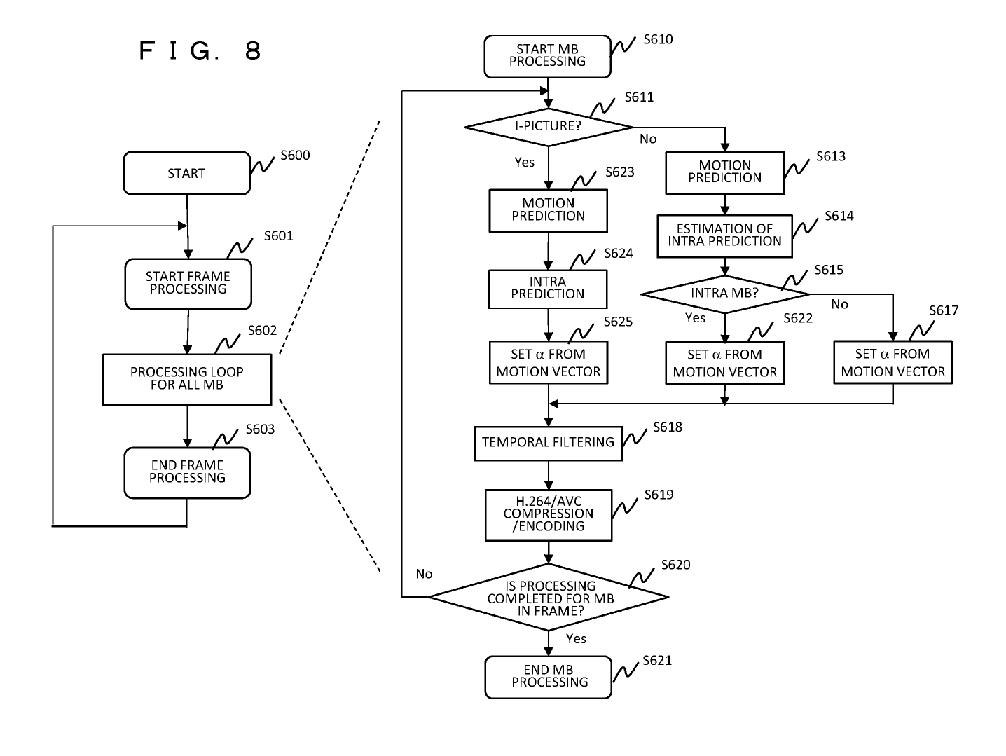

FIG. 8 is a diagram illustrating a flow of the encoding process including a temporal filter. Like reference numerals denote like elements as in the processing of FIG. 6 of the first embodiment. In this embodiment, motion prediction and intra prediction are also performed for each macroblock MB in the I-picture as illustrated in S623 to S625, and the coefficient α is set on the basis of the motion information. When the intra prediction is also used for the P-picture and the B-picture similarly to the macroblock MB in the I-picture, the value α is set depending on a magnitude of the motion vector at the time of motion prediction as indicated in S622. In S618, temporal filtering is performed using the motion vector and the coefficient α.

In the temporal filtering according to this embodiment, a frame interval between the original image and the reference image is different. For example, the interval between the I-picture and the P-picture is set to two frames, and the interval between the B-picture and the P-picture is set to one or two frames. For this reason, a correlation between the original image and the reference image changes. Considering this fact, by setting the weighting coefficient α during synthesis of the temporal filter to be smaller as the frame interval increases, it is possible to provide uniform filter characteristics across the I-picture, the P-picture, and the B-picture.

Note that the order of the I-picture, the P-picture, and the B-picture illustrated in FIG. 7 or the frame interval of each type of picture are merely exemplary, and it is natural that the aforementioned processing may also be applied to any picture sequence.

### Third Embodiment

In a third embodiment, an image processing system including a network camera obtained by applying the image compression according to the invention and a controller connected to the network camera to perform an image decompression and output operation will be described. This image processing system also has a capability of efficiently improving an image compression rate while maintaining a resolution of the attention area at the time of photographing as well as the white noise removal described in the first and second embodiments.

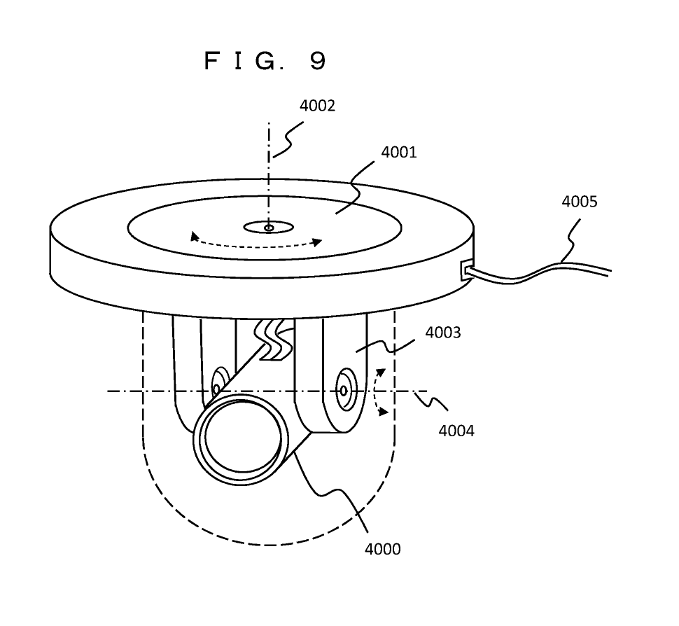

FIG. 9 is a diagram illustrating an exterior configuration of the network camera according to the third embodiment. The network camera 4000 (hereinafter, simply referred to as a camera) is installed in a turntable 4001 with a camera support post 4003 and is rotatable around two rotation shafts 4002 and 4004 using a pair of built-in motors. A shooting direction of the camera 4000 is instructed from a controller (not illustrated) connected to the network cable 4005. The image photographed by the camera 4000 is subjected to the image processing described below and is transmitted to the controller via the network cable 4005. By installing such a camera in, for example, a retail shop for surveillance and periodically shooting images by rotating the camera, it is possible to monitor a plurality of points using a single camera.

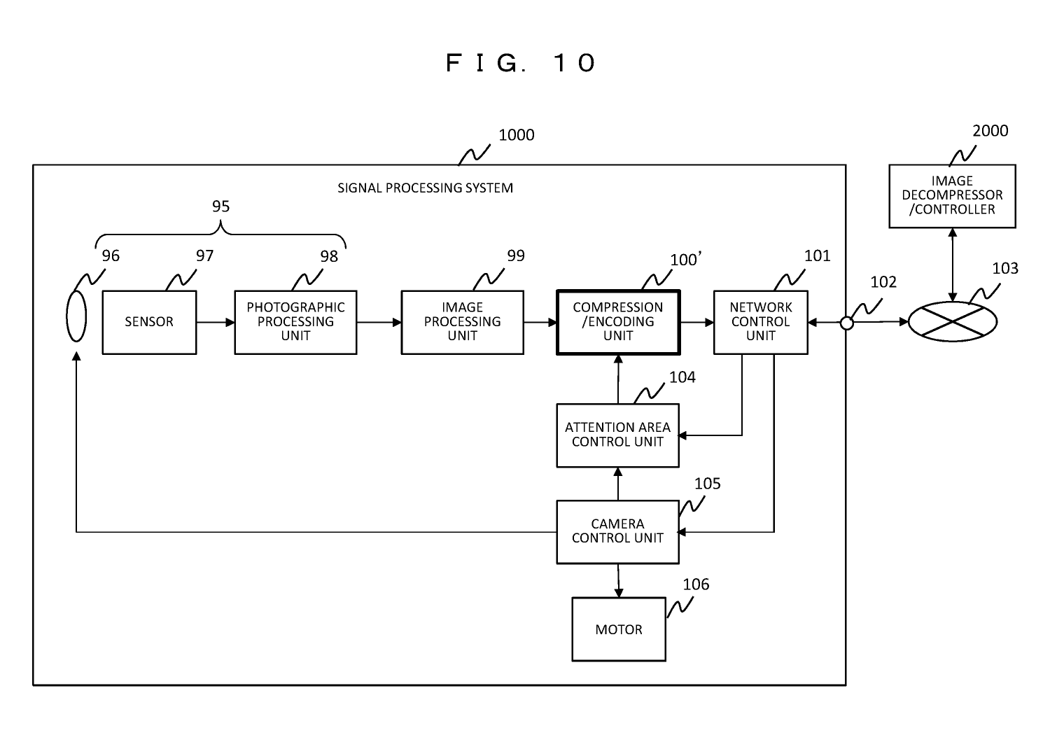

FIG. 10 is a diagram illustrating a block configuration of the image processing system. Signal processing in the network camera 4000 of FIG. 9 is performed using the signal processing system 1000, which is connected to the image decompressor/controller 2000 via the local area network (LAN) 103 constructed with the network cable 4005.

In the camera unit 95 of the signal processing system 1000, information on external light received from a lens unit 96 is converted into digital data on the basis of the photoelectric effect using a sensor 97, and the photographic processing unit 98 converts it into image data expressed by a luminance, a color difference, and the like based on the pixel arrangement of the sensor. The image processing unit 99 performs a resolution emphasis in a frame, gain correction, noise removal using a two-dimensional filter in a frame, and the like. The compression/encoding unit 100′ corresponds to the image compression apparatus 100 described in the first and second embodiments, and performs noise removal and compression/encoding. Then, packetization is performed to form a packet that can be transmitted using a network control 101 via the Ethernet (registered trademark), and the compressed stream data is output from the terminal 102 to the outside.

The camera control unit 105 controls the turntable 4001 of FIG. 9 and the motor 106 of the support post 4003 to notify information on the current shooting direction of the camera unit 95 to the attention area control unit 104. This information includes a turning angle and an elevation angle of the rotation axes 4002 and 4004 with respect to a reference direction. In addition, the camera control unit 105 transmits a signal for controlling a zoom ratio to the lens unit 96, and notifies the zoom information to the attention area control unit 104.

The attention area control unit 104 determines what is a state of the scene under shooting, that is, a positional relationship with the attention area set in advance from the controller 2000 on the basis of the turning angle, the elevation angle, and the zoom information received from the camera control unit 105.

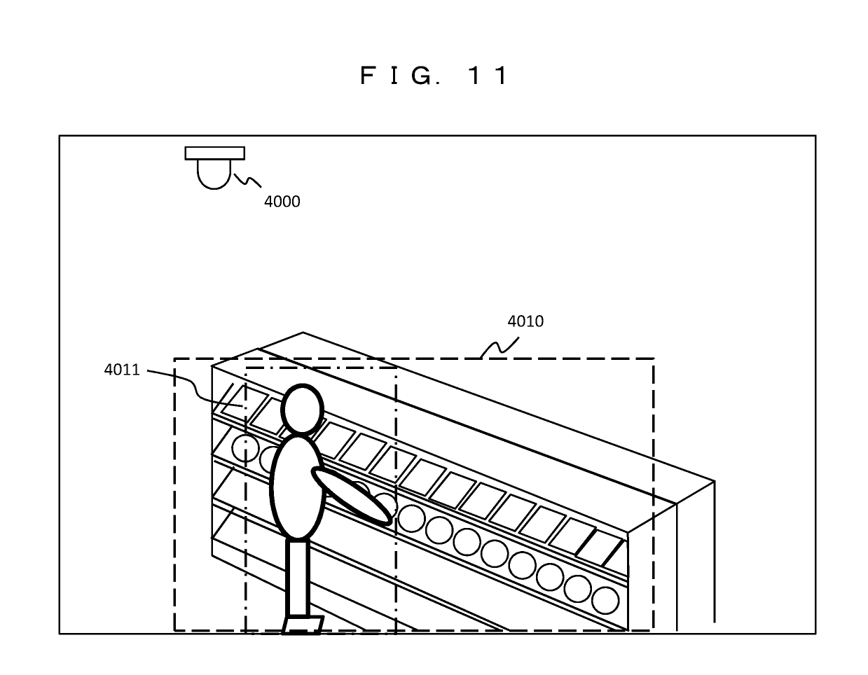

FIG. 11 is a diagram illustrating an exemplary setting of the attention area. It is assumed that a camera 4000 is installed on a ceiling of a certain shop to photograph the inside of the shop using the turning angle, the elevation angle, and the zoom ratio set in advance. In this case, for example, an area 4010 in the vicinity of a display cabinet in the shop is set as the attention area. As a setting method, when operating the camera, a user manipulates the controller 2000 to adjust the turning angle, the elevation angle, and the zoom ratio as indices using upper left coordinates and lower right coordinates of the attention area 4010 and registers a degree of attention on this area.

Information concerning the attention area is transferred from the attention area control unit 104 to the compression/encoding unit 100′ before the start of image compression of each frame. The compression/encoding unit 100′ receives the information on the attention area from the terminal 29 of FIG. 1 and stores it in the encoding parameter control unit 28.

The encoding parameter control unit 28 determines whether or not each macroblock MB is within the attention area 4010 whenever the encoding control of the first embodiment is performed for the macroblock MB. This is determined on the basis of whether or not a part of the coordinates of the macroblock MB exists in a rectangular area set as the attention area 4010. If the macroblock MB belongs to the attention area 4010, a process of prioritizing the image resolution is performed. If the macroblock MB does not belong to the attention area 4010, a process of prioritizing compression efficiency is performed.

The encoding parameter control unit 28 determines the degree of attention of each macroblock MB on the basis of the motion vector transmitted from the fine motion search unit 15. For example, in an area where a large motion is detected, it is highly likely that different pictures are updated in every frame. Therefore, as a surveillance camera, it is expected that the degree of attention increases by checking the image thereafter. For this reason, as the motion vector is larger, the degree of attention is set to be higher, and similarly, a process of prioritizing the image resolution is performed. In this manner, by setting the degree of attention depending on the magnitude of the motion vector, for example, it is possible to increase a resolution of the area 4011 including a person moving in the shop as illustrated in FIG. 11.

As described above, the encoding parameter control unit 28 obtains the degree of attention of each macroblock MB as β0 and β1 on the basis of whether or not the macroblock belongs to the attention area and the magnitude of the motion vector and computes a total degree of attention β of each macroblock MB on the basis of Equation (5). Note that the values β0 and β1 are set to be larger as the degree of attention increases.

β=β0·β1(where 0≤β0 and β1≤1) (5)

The degree of attention β computed in this manner is reflected in the weighting coefficient α in the temporal filtering described in the first embodiment.

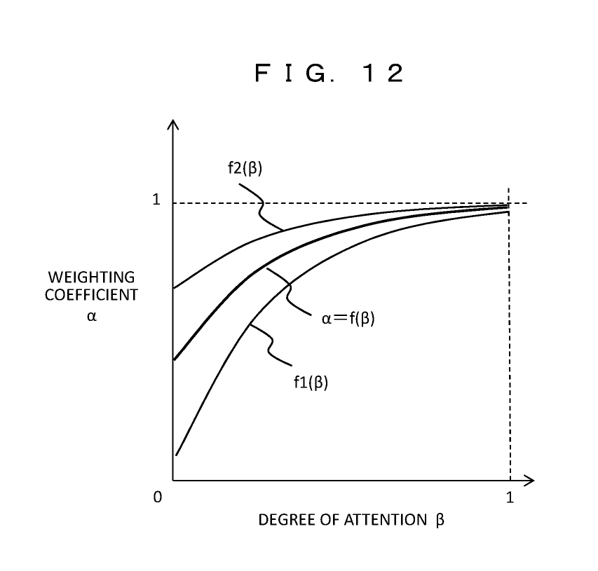

FIG. 12 is a diagram illustrating a relationship between the degree of attention β and the coefficient α used in filtering. The weighting coefficient α of Equation (1) of the temporal filter of the first embodiment is determined on the basis of a function “α=f(β)” depending on the degree of attention β. As the degree of attention β increases, the coefficient α is set to be larger, so that the resolution is improved by increasing a synthesis ratio of the original image. If the degree of attention β is small, the coefficient α is set to be smaller, so that encoding efficiency is improved by increasing the synthesis ratio of the reference image.

Specifically, a numerical table based on the function f(β) may be created, the value of β (0 to 1) may be divided into, for example, 128 steps, and the coefficient α corresponding to each value β may be read from the table.

The encoding parameter control unit 28 changes a gradient of the function α=f(β) to be applied depending on a state of the generated code amount of each macroblock MB. The current generated code amount is successively transmitted from the variable-length encoding unit 22 to the encoding parameter control unit 28. An actual bit rate is calculated by sequentially accumulating the generated code amount and is compared with a target bit rate. If the generated code amount is excessive with respect to the target bit rate, a function f1(β) having a steep gradient is used instead of the function f(β) to suppress the generated code amount. This reduces the coefficient α and increases the synthesis ratio of the reference image. As a result, the difference value between the reference image and the original image expressed in Equation (4) can be further reduced, so that it is possible to suppress the generated code amount.

Conversely, when the generated code amount is lower than the target bit rate, the coefficient α is set to be larger by changing the function into a function f2(β) having a moderate gradient, and the synthesis ratio of the original image increases. As a result, it is possible to improve a resolution of the synthesis image and increase the bit rate.

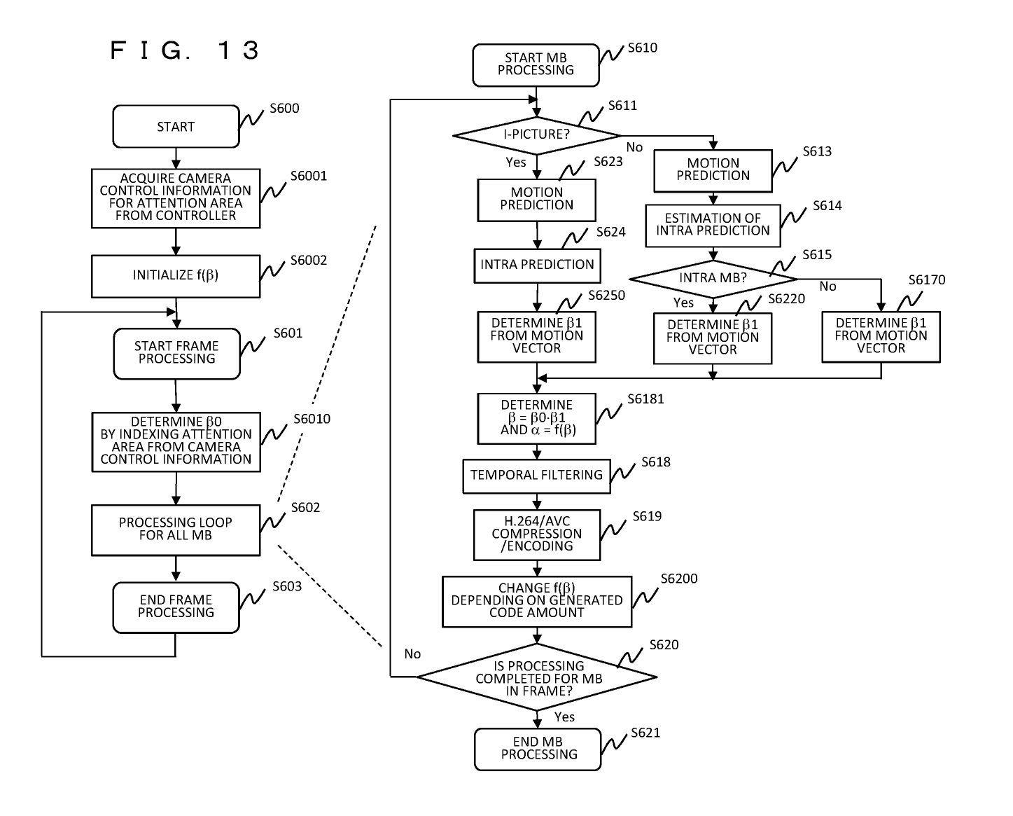

FIG. 13 is a diagram illustrating a flow of the encoding process including a temporal filter. A characteristic process different from the aforementioned embodiments will be described.

In S6001, the camera control unit 105 acquires the camera control information for the attention area from the controller 2000, and initializes the function f(β) in S6002.

In S6010, the compression/encoding unit 100′ determines the degree of attention β0 corresponding to each macroblock MB by indexing the attention area on the basis of the camera control information for each frame.

In S6170, S6220, and S6250, the compression/encoding unit 100′ determines the degree of attention β1 on the basis of the calculated motion vector of each macroblock MB.

In S6181, a total degree of attention β is calculated on the basis of Equation (5), and the coefficient α suitable for this value is determined on the basis of the function f(β). In S6181, temporal filtering is performed using this coefficient α.

In S6200, the current generated code amount is compared with the target bit rate, and the function f(β) used in S6181 is changed as illustrated in FIG. 12.

As described above, according to this embodiment, by changing the coefficient used in the temporal filtering depending on the attention area, the motion vector, and the generated code amount, it is possible to implement an image processing system capable of improving compression/encoding efficiency while maintaining image quality depending on the degree of attention.

### Fourth Embodiment

In a fourth embodiment, an image compression apparatus having a pair of temporal filters will be described.

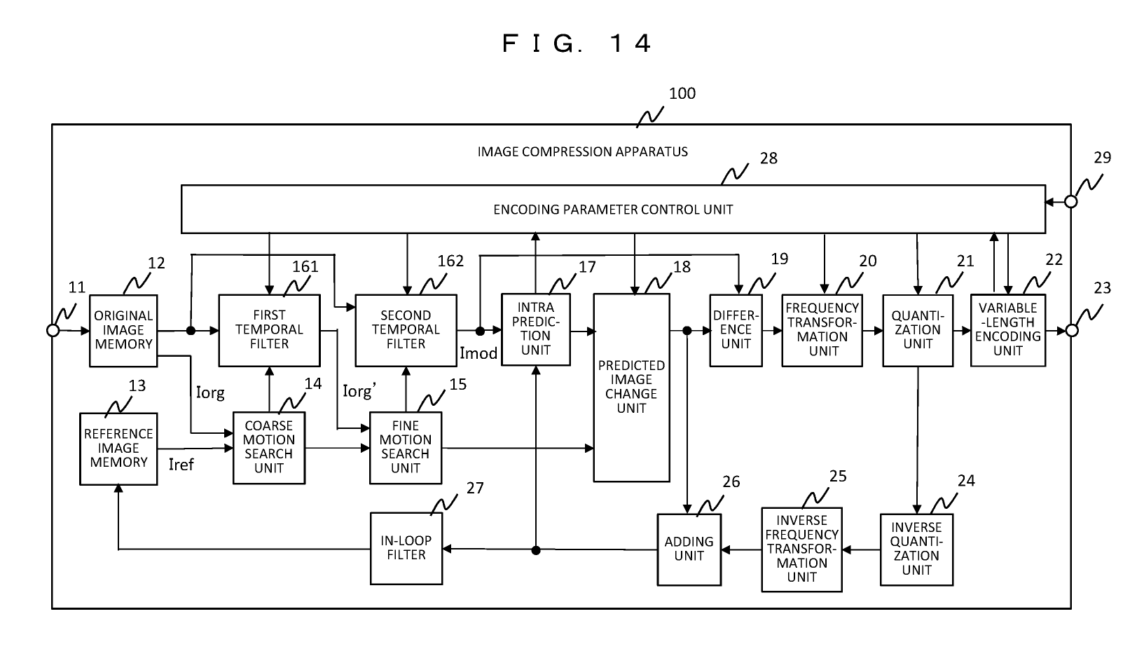

FIG. 14 is a diagram illustrating a block configuration of the image compression apparatus according to the fourth embodiment. Like reference numerals denote like elements as in the first embodiment, and they will not be described repeatedly. Since the temporal filtering is performed in two steps, the image compression apparatus has first and second temporal filters 161 and 162.

The first temporal filter 161 performs provisional temporal filtering between the original image and the reference image using the motion vector obtained from the coarse motion search unit 14. Then, the fine motion search unit 15 obtains a final motion vector for the image subjected to the provisional temporal filtering. The second temporal filter 162 performs temporal filtering between the original image and the reference image again on the basis of this final motion vector.

That is, the fine motion search unit 15 of the first embodiment performs motion prediction for the original image Iorg from the original image memory 12. However, the fine motion search unit 15 according to this embodiment performs motion prediction for the image Iorg′ subjected to the processing of the first temporal filter 161. As a result, compared to the first embodiment, it is possible to perform fine motion search for the image in which a difference of the white noise or the like is reduced. It is possible to improve accuracy of motion prediction for the image having a lot of noise.

### Fifth Embodiment

In a fifth embodiment, a decoding process for restoring an original image by applying inverse transformation of the filtering to the image subjected to temporal filtering at the time of image compression will be described.

In the first to fourth embodiments described above, compression/encoding efficiency is further improved by applying temporal filtering to the original image. As a common characteristic, the coefficient α that determines the synthesis ratio with the reference image in the temporal filtering can be expanded such that a side that receives and decodes the compression data can variably control the value of the coefficient α of each pixel using only a factor that can be specified and reproduced in the decoding side.

In the first to fourth embodiments, in addition to the macroblock of intra prediction, the coefficient α is determined on the basis of the motion vector of the image compression/encoding existing in the bit stream. In the second embodiment, the coefficient α is determined from the motion vector of the image compression/encoding and the order of the I-picture, the P-picture, and the B-picture. In the third embodiment, the coefficient α is determined on the basis of the attention area, the magnitude of the motion vector, the generated code amount, and the target bit rate. This means, when data is transmitted after image compression, temporal filtering is strengthened to enhance the compression/encoding efficiency, and as a result, the decoding side can perform inverse transformation to restore a portion corresponding to the lost resolution. As a result, it is possible to construct a new image transmission system.

When such an image transmission system is constructed according to any one of the first to fourth embodiments, a motion vector is not transmitted for an image subjected to intra prediction in the related art. Therefore, in an extended version, even in intra prediction, similar to the motion compensation, information for specifying a location of the reference image used in the temporal filter is transmitted. Alternatively, a mode is restricted so as not to perform temporal filtering, that is, equivalent processing is performed by setting α=1 in Equation (1). In addition, for the attention area of the third embodiment, information β0 regarding the attention area of each frame may be transmitted from the compression/encoding side to the decoding side. As a result, it is possible to calculate the degree of attention β=β0·β1 as intensity information of the temporal filter in each macroblock MB. In addition, it is possible to calculate the code amount of each macroblock MB in the decoding side in a similar way to that of the encoding side and reproduce transformation of the function f(β) for determining the coefficient α.

According to this embodiment, as an image processing system having the aforementioned capabilities, an image processing system that transmits an image is selected by combining the network camera of the third embodiment and the image decoding apparatus having a temporal filter restoration means by way of example.

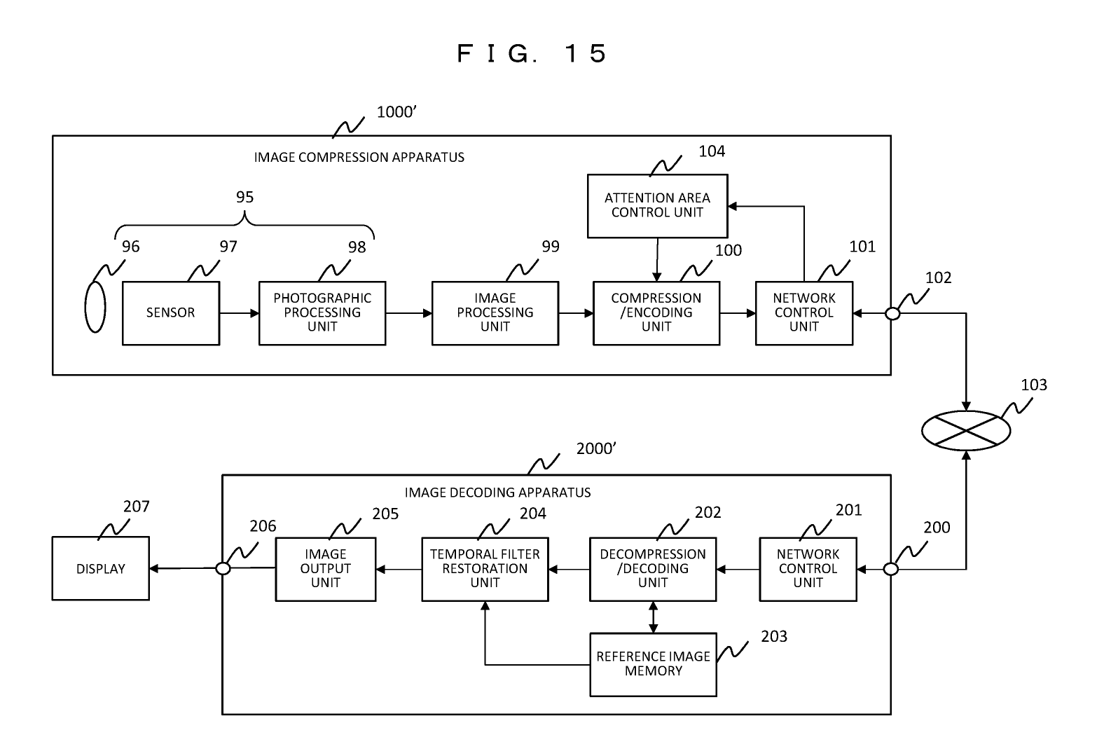

FIG. 15 is a diagram illustrating a block configuration of the image processing system according to the fifth embodiment. The image compression apparatus 1000′ corresponds to the signal processing system 1000 of FIG. 10, and a part of the blocks relating to the camera control are not illustrated for simplicity purposes. The encoded data of the photographic image created by the image compression apparatus 1000′ is input to the image decoding apparatus 2000′ via the network (LAN) 103. The image decoding apparatus 2000′ corresponds to the image decompressor/controller 2000 of FIG. 10. The image decoding apparatus 2000′ decodes the transmitted encoded data pursuant to the compression/encoding standard and outputs the decoded image to a display unit such as the display 207.

Next, a configuration and operations of the image decoding apparatus 2000′ will be described. The network control unit 201 removes packet header information regarding the network or the like from the bit stream input from the network connection terminal 200, extracts only the image encoding data, and transmits it to the decompression/decoding unit 202. The decompression/decoding unit 202 performs the image decoding of the related art pursuant to the standard used in compression of the image compression apparatus 1000′. In this case, each reference image is input to the reference image memory 203. The temporal filter restoration unit 204 performs inverse transformation of the temporal filtering as described below for the decoded image, and the resulting data is output to the display 207 via the image output unit 205 and the output terminal 206.

Operations of the temporal filter restoration unit 204 will be described in details. First, since quantization and frequency transformation are performed for the pixel data Imod(x, y) subjected to the temporal filtering in the image compression apparatus 1000′ during image compression, the pixel data contains an error caused by the image compression. Therefore, after the decoding of the decompression/decoding unit 202, the data Imod(x, y) is changed to Imod′(x, y).

The decoded image is transmitted to the temporal filter restoration unit 204. Here, inverse transformation for the temporal filtering performed by the compression/encoding unit 100 of the image compression apparatus 1000′ is performed. That is, inverse transformation of Equation (1) is performed. The restored image Iorg′(x, y) is expressed as Equation (6)

Iorg′(x,y)=(I mod′(x,y)−(1−α)Iref(x,y))/α (6),

where, in the case of α=0, Iorg′(x, y)=Iref(x, y).

Similar to a typical decoding process, the image Iref(x, y) is employed because the decoding data perfectly identical to the image data referenced during compression exists in the reference image memory 203. In addition, for a reference location of the reference image for the temporal filtering, information selected for the motion compensation is specified on the basis of the encoded stream and the compression/decoding rule (in this embodiment, H.264/AVC).

Note that a parameter not defined in the H.264/AVC standard may be treated as follows. Information regarding the attention area described in the third embodiment and necessary to determine the coefficient α is transmitted from the image decoding apparatus 2000′ to the image compression apparatus 1000′ via the network 103. For example, by multiplexing information on the attention area and the degree of attention β0 and β1 into a packet and transmitting it to the user's area of each frame, it is possible to determine the coefficient α by sharing the information on the attention area.

The magnitude of the motion vector can be specified from the motion vector information contained in the stream for the inter prediction image. In the case of intra prediction for the macroblock MB belonging to the I-picture or the P-picture and the B-picture, the temporal filter is not performed by the image compression apparatus 1000′, so that the image decoding apparatus 2000′ can compute Iorg′(x, y) by setting α=1. Alternatively, when the motion prediction and the temporal filtering are performed, a common rule is shared between the image compression apparatus 1000′ and the image decoding apparatus 2000′. Alternatively, although there is no indication in the H.264/AVC standard, motion vector information defining the temporal filter may be separately defined for the intra image and may be shared by transmitting it. This process may be defined by a typical method performed in the encoding standard used to transmit the motion vector or the reference frame for the motion compensation transmitted using the P-picture and the B-picture.

In the temporal filter restoration process, for example, as a result of the temporal filtering for the original image, the image compression efficiency is remarkably improved. When the image becomes different from the original image state, it is possible to transform the image so as to restore the information of the original image. Note that, since real number computation is performed in Equations (1) and (6), an error caused by computation accuracy is inevitable, and this method does not mean perfect restoration of the original image. However, compared to the case of the related art where the decoded image not subjected to the restoration is displayed on the display 207, it is obvious that there is an effect of restoring the image so as to be close to the original image.

Although the temporal filtering is not performed for the intra prediction in the aforementioned embodiments, by newly setting the stream encoding rule and transmitting the reference frame information and the motion vector for the temporal filtering using the common rule between the encoding side and the decoding side at the time of intra prediction, it is possible to restore the coefficient α and the image Iref(x, y) from the function f(β).

A processing flow according to this embodiment will now be described separately for the encoding process and the decoding process.

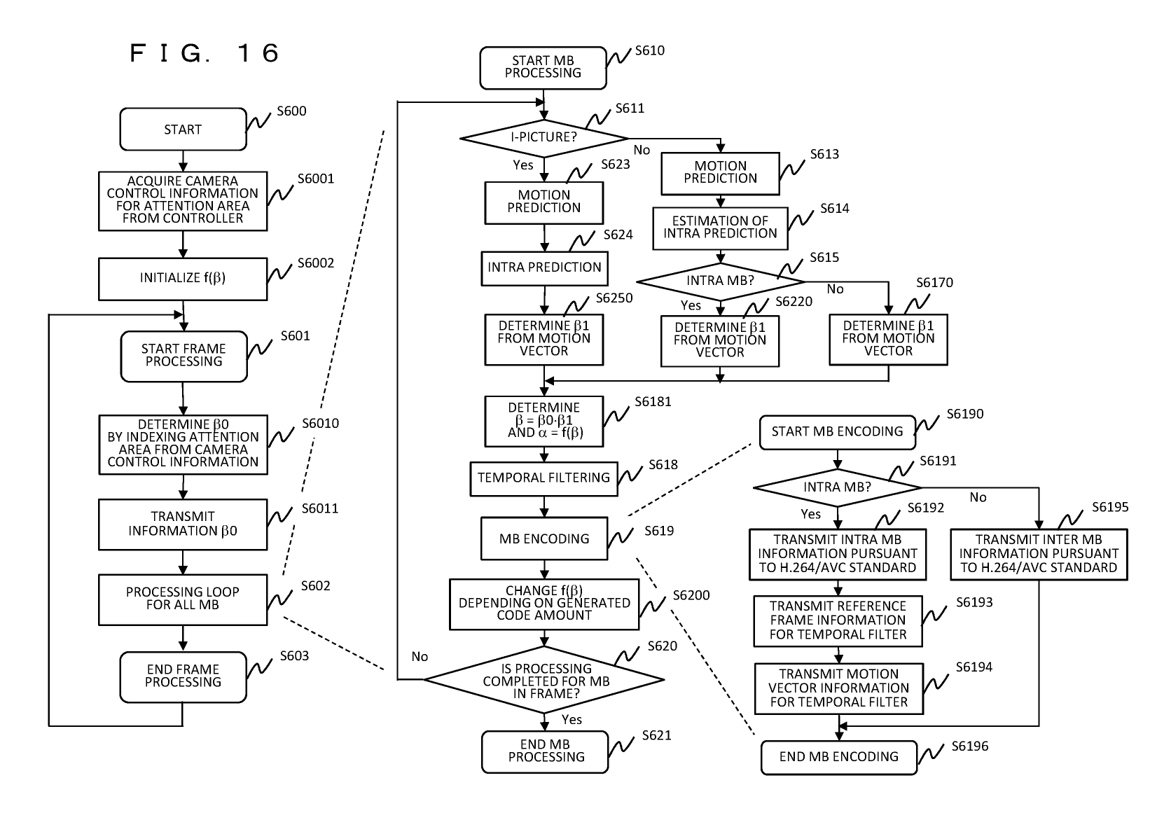

FIG. 16 is a diagram illustrating a flow of the encoding process including the temporal filter performed by the image compression apparatus 1000′. A characteristic process out of them will be described.

In S6011, the image compression apparatus 1000′ transmits the data on the degree of attention β0 of each frame to the image decoding apparatus 2000′ when the position information of the camera is determined, and the degree of attention β0 is calculated.

In S6193 and 56194, the image compression apparatus 1000′ transmits, to the image decoding apparatus 2000′, information on the temporal filter reference frame and information on the temporal filter motion vector as a parameter used in the temporal filtering (S618) for the I-picture or in the macroblock MB to which intra prediction is applied. As a result, the temporal filter restoration unit 204 of the image decoding apparatus 2000′ can also perform a temporal filter restoration process for the intra frame. Note that, when temporal filtering is not performed for the I-picture or intra prediction macroblock MB, it is not necessary to transmit such additional information.

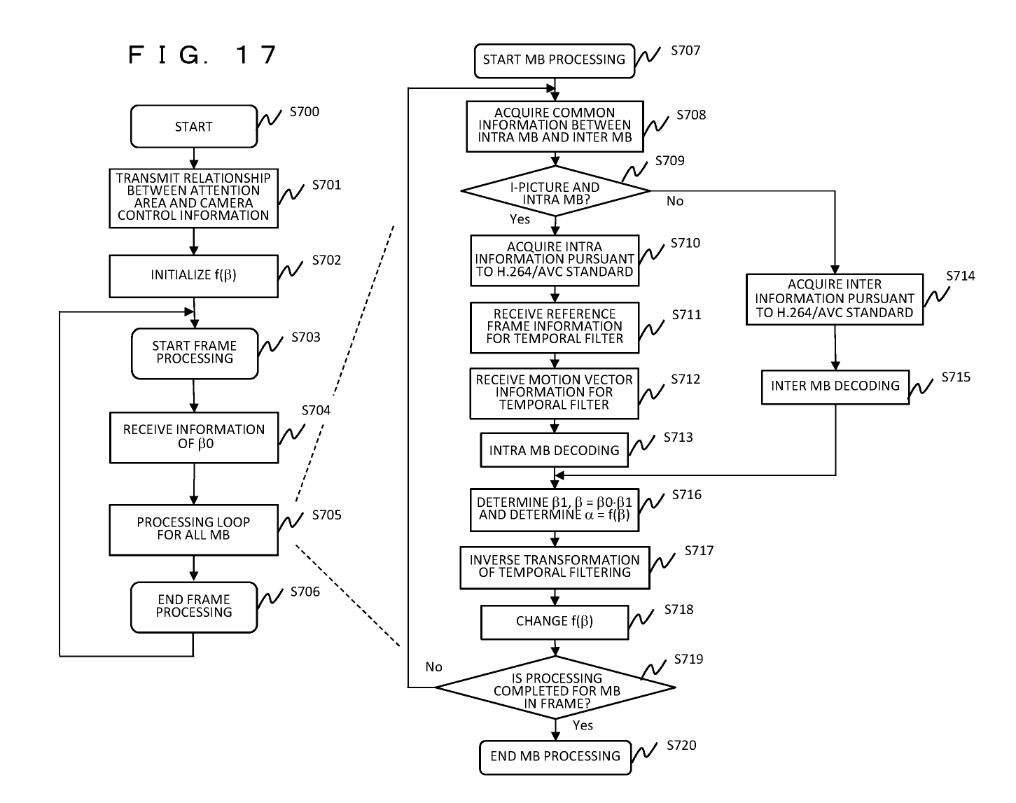

FIG. 17 is a diagram illustrating a flow of the decoding process including temporal filter restoration in the image decoding apparatus 2000′.

In S701 at the start of the operation, the image decoding apparatus 2000′ transmits a relationship between the attention area and the camera control information to the image compression apparatus 1000′ and initializes the function f(β) in S702 similarly to the case of the encoding process. Whenever the processing of each frame starts, in S704, information β0 transmitted from the image compression apparatus 1000′ is received, and the macroblock processing loop of S705 is entered.

In the processing of each macroblock MB, in S708, decoding is performed for common information between the intra prediction macroblock MB and the inter prediction macroblock MB pursuant to the H.264 standard.

In the case of the I-picture or the intra prediction macroblock MB, the information regarding the intra prediction pursuant to the standard is decoded in S710, and the reference frame information and the motion vector information used in the temporal filtering are then acquired in S711 and S712. In S713, through the processing pursuant to the standard, a reference image for intra prediction is created, and the decoding is performed. Meanwhile, in the case of the inter prediction macroblock MB, information regarding typical intra prediction pursuant to the H.264 standard is acquired in S714, and the decoding is performed in S715.

After the intra prediction or the inter prediction is performed, in S716, the degree of attention β1 in each macroblock MB is determined on the basis of the encoding information transmitted from the image compression apparatus 1000′ or an implicit rule. Furthermore, the coefficient α=f(β) is determined by applying the degree of attention β0 received in S704 at the start of the frame. In S717, using the motion vector information and the determined coefficient α, inverse transformation of the temporal filter is performed inversely to the encoding. Then, by changing the function f(13) on the basis of the same rule as that of the image compression apparatus 1000′ in S718, consistency of the computation rule of the coefficient α is maintained to match that of the encoding side.

According to this embodiment, when a part of the information of the original image is lost due to the temporal filtering, it is possible to restore a part of the information of the original image by performing the temporal filter restoration process in the decoding side.

### Sixth Embodiment

In a sixth embodiment, a case where the image processing system of the fifth embodiment is applied to the image recording/reproduction system will be described.

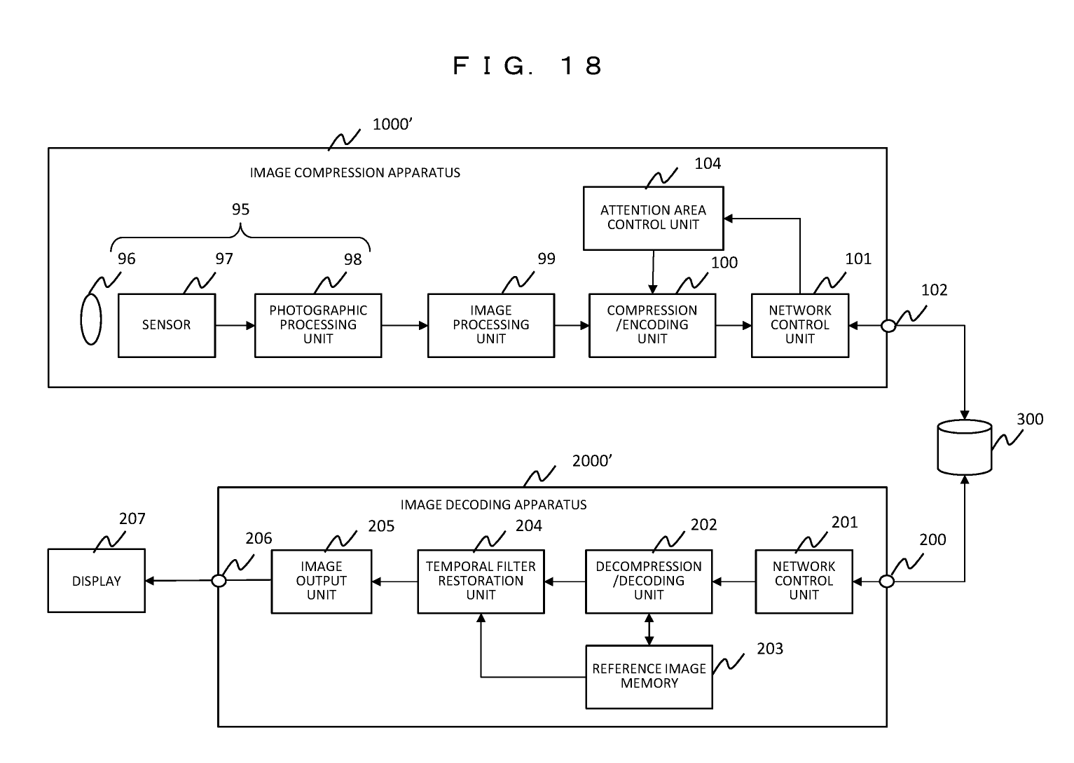

FIG. 18 is a diagram illustrating a block configuration of the image recording/reproduction system according to the sixth embodiment. In FIG. 18, the network 103 of FIG. 15 is substituted with a recording medium 300.

In this embodiment, the image data subjected to the compression/encoding is stored in the recording medium 300. However, due to the effect of the temporal filtering during the compression/encoding, compression efficiency is higher compared to the related art. As a result, it is possible to record the data in the recording medium having the same capacity as that of the related art for a longer period of time.

In addition, at the time of reproduction, due to the effect of the temporal filter restoration process, it is possible to restore the resolution lost by the temporal filtering and improve a necessary image checking work.

### Seventh Embodiment

In a seventh embodiment, as a modification of the image compression apparatus of the first embodiment, a configuration in which the reference image used in the temporal filtering is changed will be described.

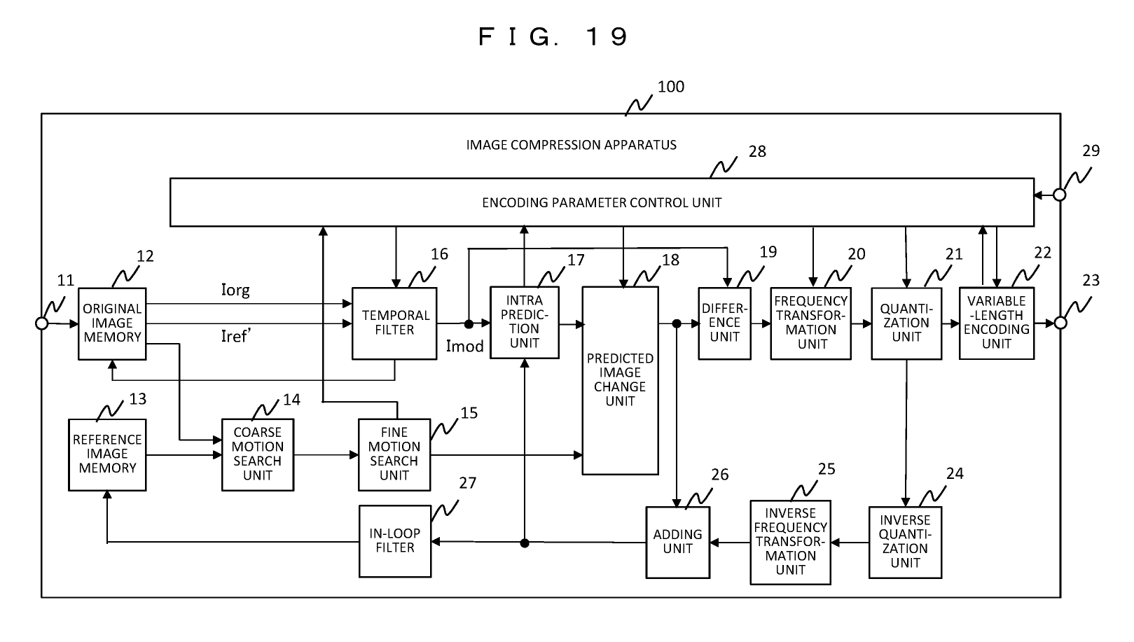

FIG. 19 is a diagram illustrating a block configuration of the image compression apparatus according to the seventh embodiment. Like reference numerals denote like elements as in the first embodiment (FIG. 1), and they will not be described repeatedly. In the first embodiment, the reference image referenced by the temporal filter 16 is the reference image used in the motion compensation at the time of image compression encoding. However, in the temporal filter 16 according to this embodiment, an image obtained by once applying temporal filtering to the original image Iorg is used as the reference image Iref.

However, instead of performing the temporal filtering for the original images from the original image memory 12 and the original images obtained so far, as a characteristic of this embodiment, the temporal filtering is performed for only the reference image during the compression/encoding by reflecting the motion search, the setting of the block segmentation mode, and the operation of the encoding parameter control unit 28 such as sub-pixel accuracy. Furthermore, in the case of intra prediction, a capability of turning off the temporal filter 16 is provided. In addition, the weighting coefficient α at the time of synthesis of the temporal filter 16 is determined in consideration of the compression efficiency and the degree of attention β in response to an instruction from the encoding parameter control unit 28.

Using this method, the image decoding apparatus receiving the image bit stream can uniquely obtain the coefficient α and the motion vector of each pixel because the decoding side also maintains the information obtained by decoding the encoded data and the parameter decision sequence for computation in the encoding parameter control unit 28.

In this case, the reference image Iref(x, y) in Equation (1) of the temporal filter expressed in the first embodiment is an image corresponding to the frame used in the compression/encoding, and the result of the temporal filtering that has been already computed is stored in the original image memory 12. For example, when the reference relationship between frames illustrated in FIG. 7 is used in the motion compensation of the image compression, frame images subjected to the temporal filtering corresponding to the frame 3100 to 3106 are stored in the original image memory 12.

According to this embodiment, it is necessary to newly store the original images corresponding to the reference images used in image compression. In addition, it is necessary to newly read the reference image of the original image created previously from the memory as a reference image at the time of the temporal filtering. For this reason, a system configuration becomes complicated, compared to the first embodiment. However, since noise is removed using the original image, degradation of the resolution as a reference image of the original image is reduced. Therefore, it is possible to improve the noise removal effect, compared to the first embodiment.

From the viewpoint of improving the image compression efficiency, the frame and the pixel position of the reference image used to obtain the difference during motion prediction perfectly coincide. Therefore, it is possible to maintain the effect that the filter control for improving the compression efficiency is easy to perform.

If the configuration according to this embodiment is applied to the image processing system of the fifth embodiment (FIG. 15), it is possible to handle the original image and the reference image of the decompression/decoding side in the same manner as those of compression/encoding side by allowing the temporal filter restoration unit 204 of the decompression/decoding side to reference the reference memory 203 at the time of decompression/decoding as the image Iref(x, y) as illustrated in the image decoding apparatus 2000′. Therefore, it is possible to maintain the original image restoration effect.

This is an effect obtained in the decoding side by applying, to the original image, the temporal filter restoration process in which the reference frame used in motion compensation and its coordinates can be specified on the basis of the encoding parameters in the stream and information that can be specified therefrom. According to this embodiment, it is possible to restore an image closer to the original image, compared to the fifth embodiment, even when degradation of the reference image used in the image compression/encoding is serious in an image having a low bit rate.

While the aforementioned embodiments have been described in details for easy understanding purposes, the invention is not necessarily limited to a case where all of the components described above are provided. In addition, a part of the configuration of any embodiment may be substituted with a configuration of the other embodiment. Furthermore, a configuration of a certain embodiment may be added to a configuration of the other embodiment. Moreover, any addition, deletion, or substitution may be possible for a part of the configuration of each embodiment.

### REFERENCE SIGNS LIST

12: original image memory,
13: reference image memory,
14: coarse motion search unit,
15: fine motion search unit,
16, 161, 162: temporal filter,
17: intra prediction unit,
18: predicted image change unit,
19: difference unit,
20: frequency transformation unit,
21: quantization unit,
22: variable-length encoding unit,
24: inverse quantization unit,
25: inverse frequency transformation unit,
26: adding unit,
27: in-loop filter,
28: encoding parameter control unit,
29: attention area input terminal,
95: camera unit,
98: photographic processing unit,
99: image processing unit,
100: image compression apparatus,
101: network control unit,
103: network,
104: attention area control unit,
105: camera control unit,
201: network control unit,
202: decompression/decoding unit,
203: reference image memory,
204: temporal filter restoration unit,
205: image output unit,
207: display,
300: recording medium,
1000: signal processing system,
1000′: image compression apparatus,
2000: image decompressor/controller,
2000′: image decoding apparatus,
4000: network camera,
4010: attention area.

1. An image compression apparatus for performing image compression/encoding, comprising:
a motion search unit that performs motion detection for each small area in an image between a first frame as an input image and a reference image already created in compression/encoding;
a temporal filter that performs temporal filtering for the first frame using a second frame different from the input image on the basis of a result of the motion detection;
a compression/encoding unit that performs computation of a difference from a predicted image, frequency transformation, quantization, and variable-length encoding for an image subjected to the temporal filtering; and
an encoding parameter control unit that controls an encoding parameter in the compression/encoding unit,
wherein the temporal filter determines a location of the reference image and a filter characteristic on the basis of an encoding parameter selected by the encoding parameter control unit.

2. The image compression apparatus according to claim 1, wherein the second frame is the reference image used in motion compensation of the compression/encoding unit.

3. The image compression apparatus according to claim 1, wherein the second frame is an image subjected to the temporal filtering for the input image.

4. The image compression apparatus according to claim 1, wherein the encoding parameter control unit dynamically controls a filter characteristic of the temporal filter on the basis of intra prediction or inter prediction selected as a prediction mode.

5. The image compression apparatus according to claim 1, wherein the encoding parameter control unit controls a synthesis ratio between the first and second frames in the temporal filtering depending on a magnitude of a motion vector detected by the motion search unit.

6. The image compression apparatus according to claim 1, wherein the encoding parameter control unit controls a synthesis ratio between the first and second frames in the temporal filtering depending on information on an attention area set in advance.

7. The image compression apparatus according to claim 1, wherein the temporal filter performs first temporal filtering and second temporal filtering,
the motion search unit performs coarse motion search and fine motion search,
the first temporal filtering is performed for a location of the reference image indicated by the motion vector detected in the coarse motion search, and
the fine motion search detects a final motion vector using an image subjected to the first temporal filtering.

8. The image compression apparatus according to claim 1, wherein the temporal filtering is applied even when a macroblock in the first frame performs intra prediction.

9. The image compression apparatus according to claim 1, wherein the temporal filtering is not applied when a macroblock in the first frame performs intra prediction.

10. An image decoding apparatus that performs decoding for an image subjected to compression/encoding, comprising:
a decompression/decoding unit that receives a compressed/encoded stream subjected to temporal filtering and decompresses and decodes the stream; and
a temporal filter restoration unit that performs inverse transformation of the temporal filtering for the decompressed/decoded image,
wherein the temporal filter restoration unit determines a location of a reference image and a filter characteristic for inverse transformation of the temporal filtering on the basis of an encoding parameter obtained in decompression/decoding of the decompression/decoding unit and restores an image previous to the temporal filtering.

11. The image decoding apparatus according to claim 10, wherein the reference image used by the temporal filter restoration unit is a reference image decoded in the decompression/decoding of the decompression/decoding unit.

12. A network camera used in the image compression apparatus according to claim 6, comprising:
a camera unit that converts information on external light into image data;
a camera control unit that controls a shooting direction of the camera unit;
an attention area control unit that determines a positional relationship between a current shooting area and an attention area set in advance on the basis of control information of the camera control unit; and
a compression/encoding unit that receives information regarding the attention area from the attention area control unit and compresses and encodes an image by applying temporal filtering to the image data using the image compression apparatus,
wherein compressed stream data is transmitted to a network.

13. An image processing system comprising:
the network camera according to claim 12; and
an image decoding apparatus that receives a compressed/encoded stream transmitted from the network camera and decodes an image,
the image decoding apparatus having
a decompression/decoding unit that decompresses/decodes the stream, and
a temporal filter restoration unit that performs inverse transformation of the temporal filtering for the decompressed/decoded image,
wherein the temporal filter restoration unit determines a location of a reference image and a filter characteristic for the inverse transformation of the temporal filtering on the basis of an encoding parameter obtained in decompression/decoding of the decompression/decoding unit and restores an image previous to the temporal filtering.

14. An image recording/reproduction system comprising:
the image compression apparatus according to claim 1;
a recording medium used to record and reproduce an encoded stream transmitted from the image compression apparatus; and
an image decoding apparatus that decodes an image from the encoded stream reproduced from the recording medium,
the image decoding apparatus having
a decompression/decoding unit that decompresses/decodes the stream reproduced from the recording medium, and
a temporal filter restoration unit that performs inverse transformation of the temporal filtering for the decompressed/decoded image,
wherein the temporal filter restoration unit determines a location of a reference image and a filter characteristic for the inverse transformation of the temporal filtering on the basis of an encoding parameter obtained in decompression/decoding of the decompression/decoding unit and restores an image previous to the temporal filtering.

15. An image processing method for compressing/encoding an image and decoding the compressed/encoded image,
the compression/encoding including
a motion search process in which motion detection is performed for each small area in an image between a first frame as an input image and a reference image already created in compression/encoding,
a filtering process in which temporal filtering is performed for the first frame using a second frame different from the input image on the basis of a result of the motion detection, and
a compression/encoding process in which computation of a difference from a predicted image, frequency transformation, quantization, and variable-length encoding is performed for an image subjected to the temporal filtering,
the decoding including
a decompression/decoding process in which the compressed/encoded stream subjected to the temporal filtering is decompressed/decoded, and
a filter restoration process in which inverse transformation of the temporal filtering is performed for the decompressed/decoded image,
wherein, in the filtering process, a location of the reference image and a filter characteristic are determined on the basis of an encoding parameter selected in the compression/encoding process, and
in the filtering restoration process, a location of the reference image and a filter characteristic for inverse transformation of the temporal filtering are determined on the basis of the encoding parameter obtained in the decompression/decoding process, and an image previous to the temporal filtering is restored.
